(19) United States
(12) Patent Application Publication
(10) Pub. No.: US 2005/0163064 A1
(43) Pub. Date: Jul. 28, 2005

(54) Synchronization apparatus and method for broadcasting a service stream in a mobile communication system

(75) Inventors: Kyung-Sik Choi, Seoul (KR); Jae-Seong Han, Seoul (KR); Ki-Young Song, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/051,627

(22) Filed: Jan. 27, 2005

(30) Foreign Application Priority Data
Jan. 27, 2004 (KR) 2004-5183

(51) Int. Cl. H04B 7/005; H04J 3/16

(52) U.S. Cl. 370/278; 370/468

(57) ABSTRACT

A synchronization apparatus and method in a mobile communication system. The apparatus and method include measuring transmission delay time by a Packet Control Function (PCF) or an Access Network Controller (ANC) by exchanging packets with each ANTS, and selecting via the PCF or the ANC the longest transmission delay time of the measured time as an initial wireless transmission time, transmitting by the PCF or the ANC the wireless transmission time of the packet to said each ANTS together with packets, calculating a packet waiting time, which is a difference between the time at which said each ANTS has received the packets and the time at which the corresponding packets has been actually transmitted wirelessly, and reporting the calculated packet waiting time to the PCF or the ANC, and updating via the PCF or the ANC the wireless transmission time of next packets by means of information for the packet waiting time from each ANTS, and transmitting via the PCF or the ANC the updated wireless transmission time to the ANTSs.

### PRIORITY

This application claims the benefit under 35 U.S.C. 119(a) of an application entitled “Synchronization Method for Broadcasting Service Stream in Mobile Communication System” filed in the Korean Intellectual Property Office on Jan. 27, 2004 and assigned Serial No. 2004-5183, the entire contents of which are incorporated herein by reference.

### BACKGROUND OF THE INVENTION

1. Field of the Invention

The present invention relates to a synchronization apparatus and method in a mobile communication system. More particularly, the present invention relates to a synchronization apparatus and method in a mobile communication system providing a broadcasting service.

2. Description of the Related Art

Typically, wireless mobile communication systems have been developed to provide users with voice services while ensuring user mobility. Further, various services have been provided in many areas according to the development of technology and the requirements of users. That is, not only transmission services for short messages which are the most basic service but also e-mail transmission services, Internet services, broadcasting services, and so on, have been provided to users. In order to provide these various services, Code Division Multiple Access (CDMA) mobile communication systems using synchronization schemes have been developed into an IS-95 systems. Then, systems such as CDMA-2000 systems have emerged and are being commercialized. Further, First Evolution-Data Only (1× EV-DO) systems have emerged, which are high speed dedicated data systems. Then, First Evolution-Data and Voice (1× EV-DV) systems, that is, systems capable of providing both high speed data and voice communication, have been standardized in many areas.

Since the CDMA systems as described above basically use synchronization schemes, the network operates in a synchronized state.

However, when mobile communication systems are to provide broadcasting services, it is impossible to completely provide the broadcasting services using network synchronization because the broadcasting service provided in the mobile communication system is not a broadcasting service using Sky Wave but a broadcasting service provided through a specific content server inter-working with the mobile communication system.

A broadcasting service based on a CDMA 1× EV-DO mobile communication system has the following characteristics. First, a wireless channel is not assigned to each terminal and only one channel is assigned to a plurality of terminals, so that radio resources can be conserved. Next, an Internet Protocol (IP) multicast address is used, so that back-haul resources between not only an Access Network Controller (ANC) and a Packet Control Function (PCF) but also the PCF and a Packet Data Service Node (PDSN) can be conserved. Then, since only a forward link for transmitting broadcasting content to terminals exists while a backward link does not exist, slots of channels used in the forward link are assigned according to content instead of to each terminal. Lastly, since only one channel is used for all terminals, it is possible to insert the same content into slots transmitted through each sector of each base station. Accordingly, a terminal can perform soft combining between sectors.

In a conventional CDMA 1× EV-DO mobile communication system, a forward channel is assigned according to each terminal and this channel includes a set of slots comprising one forward channel for a specific sector of a specific base station. FIG. 1 is a diagram illustrating a process in which one forward channel is assigned to each terminal for a specific sector of a specific base station. Referring to FIG. 1, a forward channel is assigned to an Access Terminal (AT) 1 in an n slot and a forward channel is assigned to an AT 2 in a (n+1) slot.

Herein, a slot assigned to each terminal is determined by a Data Rate Control (DRC) rate required by a corresponding terminal, a DRC rate required by another terminal of a corresponding sector, the priority assigned to a terminal, and so on. Accordingly, it is impossible to allow a corresponding terminal to have a constant slot because sectors have different requirements even for the same terminals. Therefore, a terminal cannot perform a soft combining for receiving signals transmitted according to sectors and combining the received signals.

FIG. 2 is a diagram illustrating an example in which the terminal cannot perform the soft combining as described above. Referring to FIG. 2, since both an Access Network Transceiver Subsystem (ANTS) 1 and an ANTS 2 assign signals to an AT 1 in an n slot, the AT 1 can receive the signals from the first ANTS 1 and the second ANTS 2 in the n slot and perform the soft-combining. However, in a (n+1) slot, the ANTS 1 assigns signals to an AT 2 and the ANTS 2 assigns signals to the AT 1. Accordingly, since the AT 1 receives the signals from only the ANTS 2, the AT 1 cannot perform the soft-combining.

However, in a broadcasting service, in which soft combining between sectors is impossible as described above, a sector in which a terminal receives signals may frequently change according to the magnitude of signals received from sectors when the terminal is located at a boundary between the sectors. Therefore, it is impossible ensure the continuity of a broadcasting service. Further, Since a broadcasting service is transmitted from a center of a cell coverage area to a cell boundary at the same rate, a terminal may receive only signals of one sector when the terminal is located at the cell boundary. Therefore, the quality of the signal may deteriorate as it travels away from the center of the cell.

### SUMMARY OF THE INVENTION

Accordingly, the present invention has been made to solve the above-mentioned problems occurring in the prior art, and it is an object of the present invention to provide a synchronization apparatus and method for a soft combining function, which enables an Access Terminal (AT) to combine signals received from each sector of each Access Network Transceiver Subsystem (ANTS) and to obtain high quality signals in a mobile communication system providing a broadcasting service.

It is another object of the present invention to provide an apparatus and method for efficiently determining a wireless transmission time of a broadcasting service packet by an Access Network Controller (ANC) or a Packet Control Function (PCF) in a mobile communication system providing a broadcasting service.

It is further another object of the present invention to provide an apparatus and method for minimizing a difference between the time at which an ANC has received a broadcasting service packet from a PCF or the time at which the PCF has received a broadcasting service packet from a Packet Data Service Node (PDSN) and the time at which the corresponding packet has been transmitted to an AT in a mobile communication system providing a broadcasting service.

It is still another object of the present invention to provide an apparatus and method for preventing a case in which a corresponding packet is not transmitted because the packet had arrived at an ANTS after the wireless transmission time had elapsed in a mobile communication system providing a broadcasting service.

In accordance with one aspect of the present invention, there is provided a synchronization apparatus and method for providing a soft combining in a broadcasting service mobile communication system. The apparatus and method comprise determining by a Packet Control Function (PCF) or an Access Network Controller (ANC) an initial value of a wireless transmission time based on a packet transmission delay to a base station, a packet waiting time in the base station, and the base station processing time; transmitting by an Access Network Transceiver Subsystem (ANTS) a difference between a time at which packets have arrived at the ANTS and the time at which corresponding packets have been transmitted to an Access Terminal (AT) to the PCF or the ANC periodically or 5 non-periodically; and determining by the PCF or the ANC the wireless transmission time of a next packet after receiving information relating to the difference between the time at which the packets have arrived at the ANTS and the time at which the corresponding packets have been transmitted to the AT, from the ANTS.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a conventional process in which a forward channel to a specific from a base station is assigned to each terminal;

FIG. 2 is a diagram illustrating a conventional system for determining whether a terminal can perform a soft combining for packets received from a first and a second base station;

FIG. 3 is a block diagram of a broadcasting service system according to an embodiment of the present invention;

FIG. 4 is a diagram illustrating a method for determining a wireless transmission time by a Packet Control Function (PCF) according to an embodiment of the present invention;

FIG. 5 is a flow diagram illustrating an operation for determining the wireless transmission time by a PCF according to an embodiment of the present invention;

FIG. 6 is a flow diagram illustrating an operation for measuring the transmission delay time by the PCF;

FIG. 7 is a diagram illustrating an example of a data packet for an error control block;

FIG. 8 is a diagram illustrating an example of an error control block obtained by adding a parity packet to the data packet of FIG. 7;

FIG. 9 is a flow diagram illustrating an operation for transmitting an error control block to an Access Terminal (AT);

FIG. 10a is a diagram illustrating an example for obtaining time, which is T_PROC by subtracting a reception time of the last data packet (packet k, m) from time “slot t” at which an Access Network Transceiver Subsystem (ANTS) transmits a first data packet wirelessly.

FIG. 10b is a diagram illustrating an example for obtaining time, which is larger than T_PROC by subtracting the reception time of the last data packet (packet k, m) from time “slot t” at which the ANTS transmits the first data packet wirelessly.

FIG. 10c is a diagram illustrating an example for obtaining time, which is less than T_PROC by subtracting the reception time of the last data packet (packet k, m) from time “slot t” at which ANTS transmits the first data packet wirelessly.

FIG. 11 is a diagram illustrating a system for updating a T_wait; and

FIG. 12 is a flow diagram illustrating an operation for transmitting an error control block to an AT according to another embodiment of the present invention.

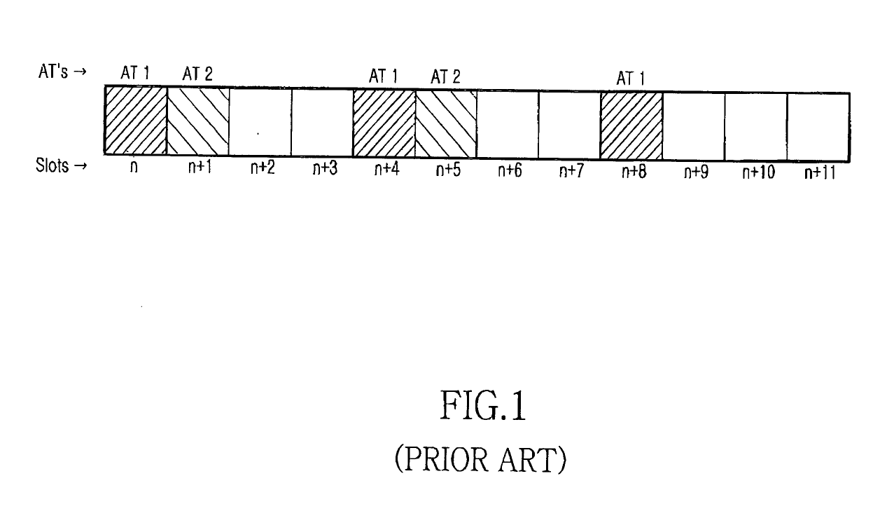

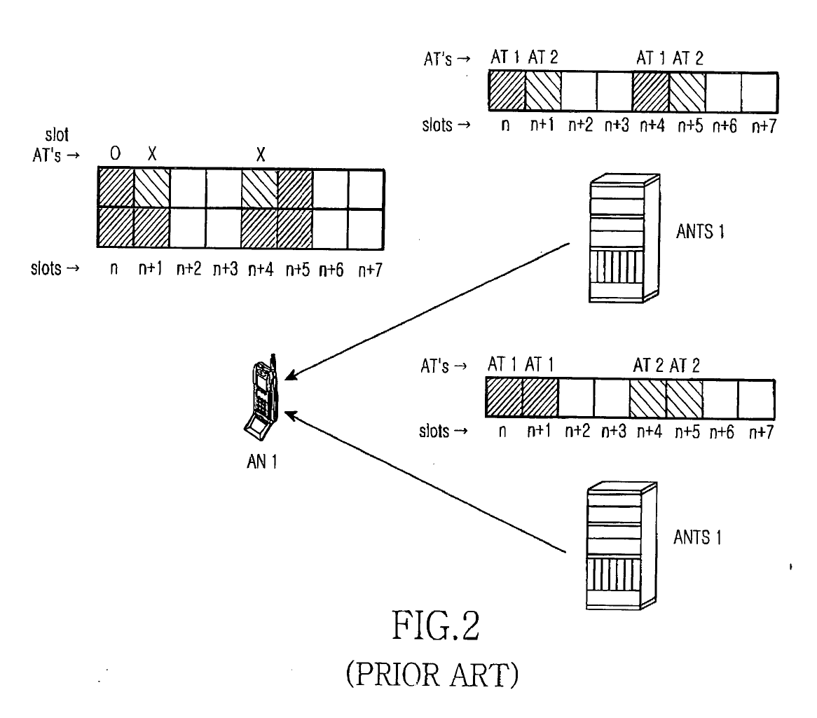

### DETAILED DESCRIPTION OF THE PREFERRED EMBODIMENTS

Hereinafter, embodiments according to the present invention will be described with reference to the accompanying drawings. In the following description of the present invention, a detailed description of known functions and configurations incorporated herein will be omitted for conciseness.

The embodiments of the present invention relate to a system and method for providing a broadcasting service in a mobile communication system. In particular, the embodiments of the present invention relate to a system and method which enable an Access Terminal (AT) to combine signals received from a plurality of Access Network Transceiver Subsystems (ANTSs) and obtain high quality signals by synchronizing packets transmitted from the plurality of ANTSs to the AT.

Moreover, the embodiment of the present invention provide a system and method for determining a wireless transmission time of broadcasting service packets by an Access Network Controller (ANC) or a Packet Control Function (PCF) in order to allow an AT to perform a soft combining after the same contents are transmitted from each ANTS through the same slots in a Code Division Multiple Access (CDMA) First Evolution-Data Only (1× EV-DO) mobile communication system providing a packet data broadcasting service.

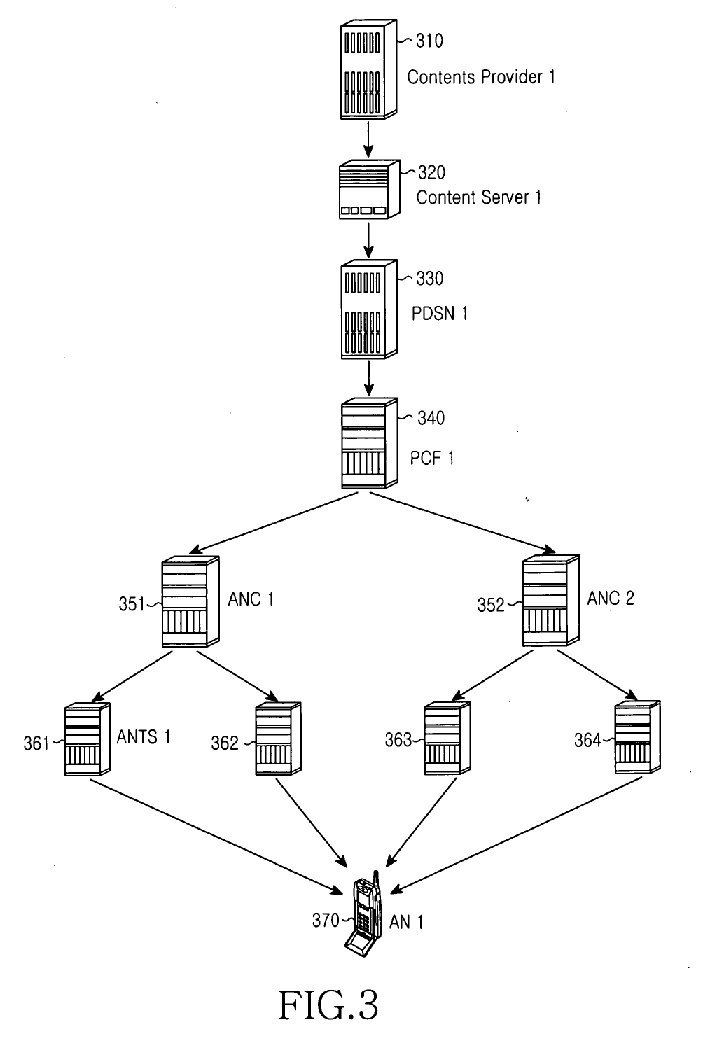

Hereinafter, from among a CDMA 2000 system, a CDMA 1× EV-DO system and a CDMA First Evolution-Data and Voice (1× EV-DV) system, which can provide the aforementioned broadcasting service, the construction and the operation of the CDMA 1× EV-DO system will be described with reference to FIG. 3.

FIG. 3 is a block diagram illustrating the construction of the CDMA 1× EV-DO system capable of providing the broadcasting service. The CDMA 1× EV-DO system for providing the broadcasting service includes a wireless AT 370, mobile communication systems 330, 340, 351, 352, 361, 362, 363 and 364 for providing the AT 370 with a high speed data service, a contents provider 310 for providing the broadcasting service, and a BCMCS content server 320.

The ANTSs 361 to 364 have predetermined wireless communication coverage and provide a data service to the AT 370 through wireless channels (not shown). The ANC 351 controls the ANTSs 361 and 362 and the ANC 352 controls the ANTSs 363 and 364. The PCF 340 is connected to the ANCs 351 and 352 and controls processing of the provided broadcasting service and high speed data service. Further, the Packet Sata Service Node (PDSN) 330 is connected to the PCF 340 and serves as an end node for connecting to the Internet network or other networks for a data service in the mobile communication system.

The BCMCS content server 320 is a server for providing broadcasting service, converts broadcasting data including video and sound for broadcasting into Internet Protocol (IP) packets, and provides the IP packets to the PDSN 330.

The present invention provides two embodiments for determining the wireless transmission time of each broadcasting service packet in the system as described above. In the first embodiment, the PCF 340 determines the wireless transmission time. Further, in the second embodiment, the ANCs 351 and 352 determine the wireless transmission time.

When the PCF 340 determines the wireless transmission time of the broadcasting service packet according to the first embodiment, it is possible to provide a soft combining function in all sectors of all ANTSs connected to the PCF 340 through the ANCs 351 and 352.

Further, when the ANCs 351 and 352 determine the wireless transmission time of the broadcasting service packet according to the second embodiment, it is possible to provide the soft combining function in all sectors of all ANTSs connected to the ANCs 351 and 352.

Hereinafter, the method for determining the wireless transmission time of the broadcasting service packet will be described using the PCF 340. Time described below has a slot unit.

For the soft-combining, all ANTSs must transmit packets including the same content to an AT in the same slots. This is possible when the wireless transmission time is determined based on an ANTS having the largest transmission delay from the PCF 340.

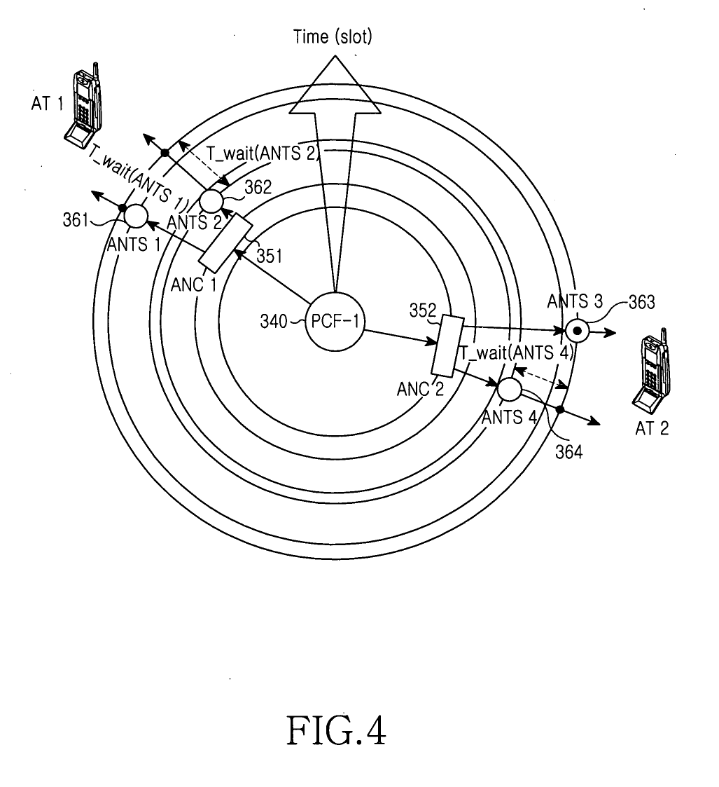

Herein, transmission delay time between the PCF 340 and each of the ANCs 351 and 352 and transmission delay time between each of the ANCs 351 and 352 and each of the ANTSs 361 to 364 may be different from one another. In FIG. 4, transmission delay time to the ANTS 363 from the PCF 340 is the longest. Accordingly, the other ANTSs 361, 362 and 364 transmit packets wirelessly according to the transmission delay time of the ANTS 363. The dotted line of FIG. 4 shows the wireless transmission time of the packets. As described above, the wireless transmission time of packets must be determined based on an ANTS having the largest transmission delay from the PCF 340. For this, each of the ANTSs 361 to 364 must inform the PCF 340 of information regarding the transmission delay time from the PCF 340 to each of the ANTSs 361 to 364.

Referring to FIG. 4, the transmission delay time may be estimated by means of waiting time T_wait from the time at which the packets have arrived at an ANTS to the time by which corresponding packets must be transmitted wirelessly. Each of the ANTSs 361 to 364 must measure this waiting time and inform the PCF 340 of the measured waiting time. The PCF 340 receives the waiting time from each of the ANTSs 361 to 364 and determines the wireless transmission time of packets based on an ANTS having the shortest waiting time.

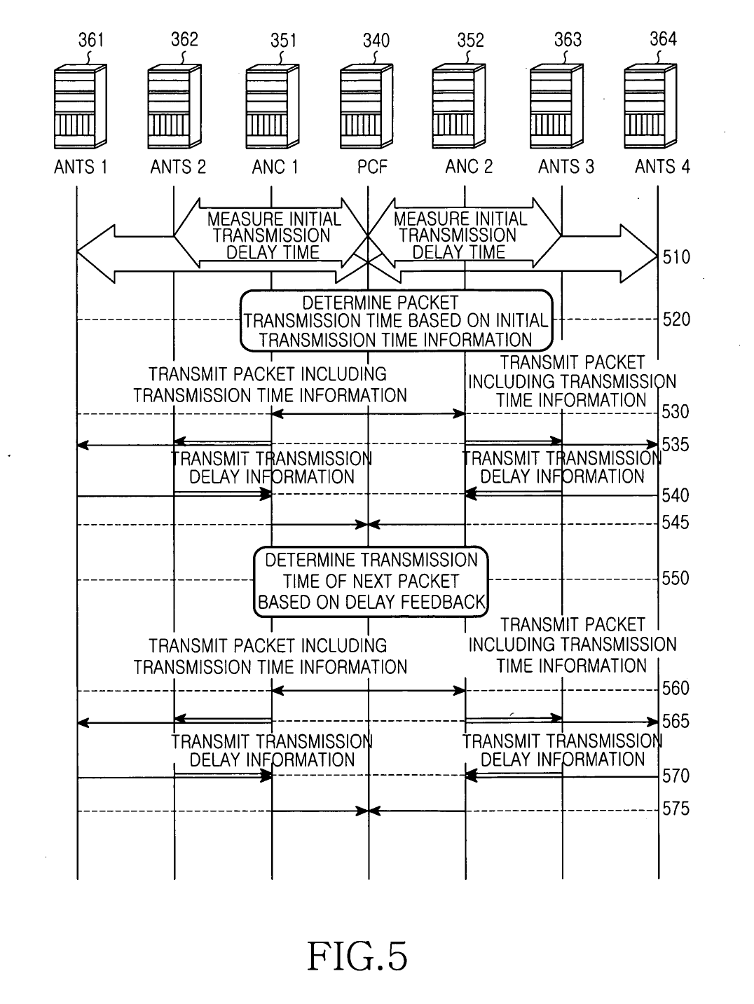

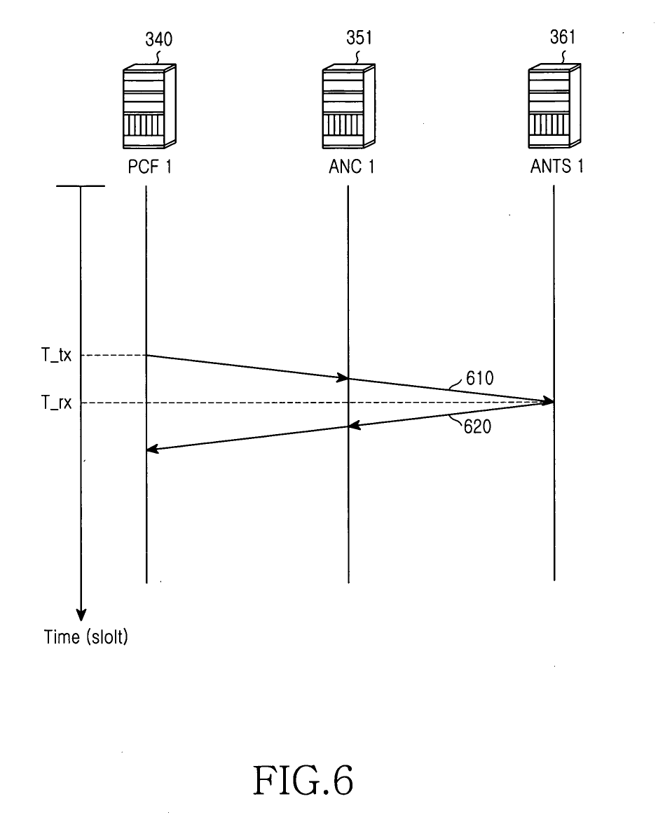

FIG. 5 is a flow diagram illustrating the operation of a PCF according to an embodiment of the present invention. Referring to FIG. 5, since the PCF 340 does not have information regarding the transmission delay from the PCF 340 to each of the ANTSs 361 to 364 initially, the PCF 340 exchanges packets with each of the ANTSs 361 to 364 and measures the transmission delay time in step 510. The detailed process of determining the initial transmission delay time is shown in FIG. 6.

FIG. 6 is a flow diagram illustrating an operation for measuring the transmission delay time by the PCF 340. Referring to FIG. 6, the PCF 340 transmits a Delay Measure Request Packet, which requests a transmission delay measurement and includes transmission time T_tx, to the ANTS 361 through the ANC 351, in step 610. The ANTS 361 receiving the Delay Measure Request Packet transmits a Delay Measure Response Packet including a reception time T_rx of the corresponding packet to the PCF 340 through the ANC 351, in step 620. The PCF 340 receives the Delay Measure Response Packet from the ANTS 361 and calculates the transmission delay time T_d by means of the following equation 1:
T_{—}d=T_{—}rx−T_{—}tx (1)

The PCF 340 calculates the transmission delay time T_d for all ANTSs by means of equation 1. Further, the PCF 340 refers to the measurement result of step 510 and determines the wireless transmission time of each packet based on an ANTS having the largest delay time, in step 520. That is, the PCF 340 sets the maximum value of the transmission delay time as an initial value T_d_init of the transmission delay time by means of the following equation 2:
T_{—}d_{—}init=MAX(T_{—}d) for all ANTS's (2)

Then, the PCF 340 transfers packets including the wireless transmission time information of the packet to each of the ANTSs 361 to 364 through each of the ANCs 351 and 352 in steps 530 and 535. Each of the ANTSs 361 to 364 calculates the difference between the time at which the packets have arrived at each of the ANTS and the wireless transmission time of the corresponding packet, and reports the calculated difference to the PCF 340, in steps 540 and 545.

The PCF 340 uses the information received from each of the ANTS when calculating the wireless transmission time of the next packet in step 550. After the wireless transmission time is determined as described above, the PCF 340 performs step 575 in step 560 by means of the wireless transmission time information calculated in step 550. Herein, the execution of step 575 in step 560 corresponds to the execution of step 545 in step 530. However, the execution of step 545 in step 530 uses the packet transmission time based on the initial transmission time in step 510, while the execution of step 575 in step 560 uses the packet transmission time, which has been determined in step 550 by means of a delay feedback result obtained by performing step 545 in step 530. Similarly steps 565 and 570 correspond to steps 535 and 570.

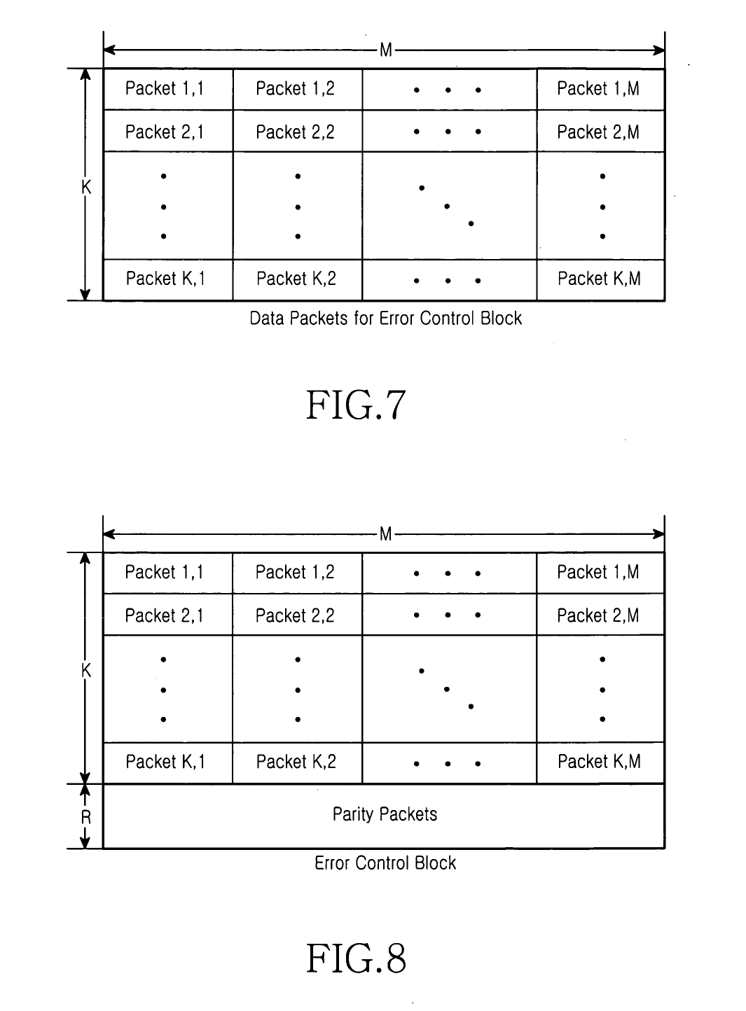

In the meantime, in the CDMA 1× EV-DO mobile communication system, a predetermined number of broadcasting service packets are converted to an error control block through a Reed-Solomon coding and are then transmitted to an AT. FIG. 7 is a diagram illustrating an example of a data packet for the error control block and FIG. 8 is a diagram illustrating an example of an error control block obtained by adding a parity packet for an error control to the data packet.

In an embodiment of the present invention, it is assumed that an ANTS performs a generation operation of the error control block.

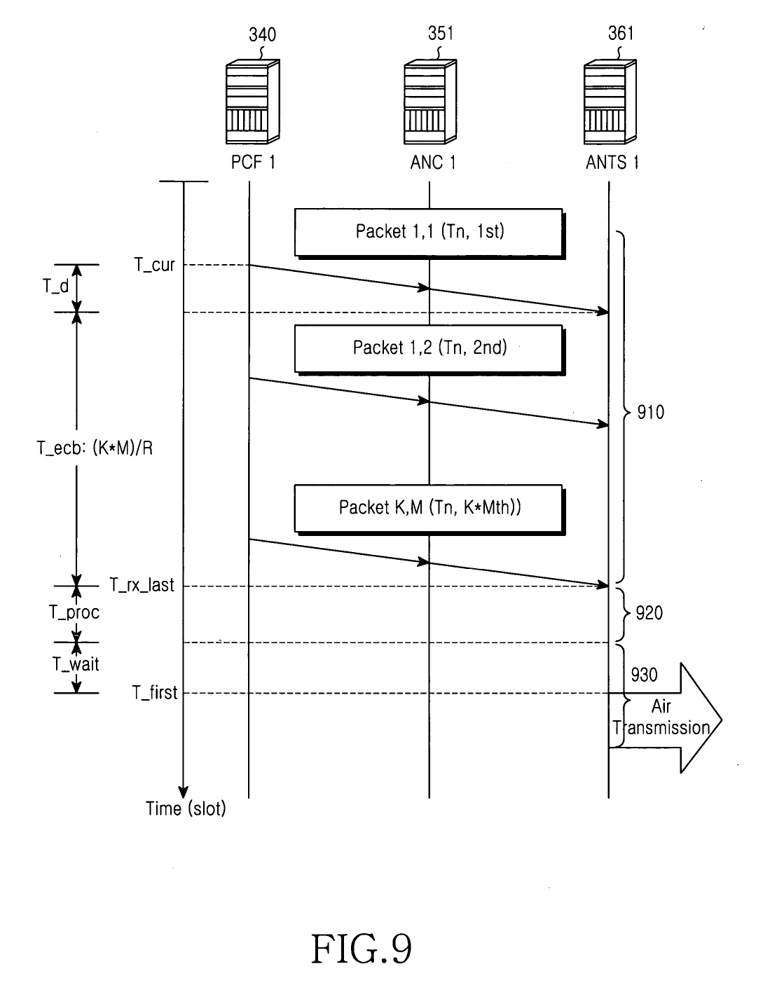

FIG. 9 is a flow diagram illustrating an operation for transmitting an error control block to an AT. In step 910, the PCF 340 transmits K*M number of data packets comprising the data portion of the error control block of FIG. 7 to the ANTS 361 through the ANC 351. Then, in step 920, the ANTS 361 creates R*M number of parity packets, which comprises the parity portion of the error control block, through a Reed-Solomon coding, and completes an error control block including N*M number of packets. Herein, the N denotes sum of the K and the R. Further, in step 930, the ANTS 361 transmits the completed N*M number of packets to an AT wirelessly at a scheduled time.

Herein, when the PCF 340 informs the ANTS 361 of wireless transmission time T_first of a first data packet comprising the data portion of the error control block for each data packet and the sequence (1^{st}, 2^{nd}, K*M^{th}) to which the corresponding data packet corresponds from the data portion of the corresponding error control block, the ANTS 361 may transmit packets to the AT in slots determined by the error control block. In FIG. 9, the T_rx_last denotes the time at which the ANTS 361 has received the last data packet, the T_proc denotes the time required for creating the error control block through the Reed-Solomon coding by the ANTS 361, the T_wait denotes the time for which the ANTS 361 waits to transmit the first packet of the data packet to an AT after completing the error control block.

The PCF transmits data packets to an ANTS at an R_pkt (packets/slot) rate and this rate is determined by a wireless transmission rate of a broadcasting service. Accordingly, the T_ecb, which is the time required for transmitting all data packets of one error control block to the ANTS, is calculated by means of the following equation 3:
T_{—}ecb=(K*M)/R_{—}pkt (3)

When the current time is a T_cur, the wireless transmission time T_first (1) of a first data packet of a first error control block is calculated by means of the following equation 4:
T_first (1)=T_{—}cur+T_{—}d_{—}mit+T_{—}ecb+T_{—}proc (4)

Further, the wireless transmission time T_first (n) of the first data packet of an n^{th} (n=2, 3, 4, . . . ) error control block is calculated by means of the following equation 5:
T_first (n)=T_first (n−1)+T_{—}ecb (5)

Actually, an ANTS providing a broadcasting service may be added to the system or ANTSs may have different time T_ds according to the traffic of a back-haul between a PCF and an ANTS. These situations may be considered through the calculation of the T_wait in an ANTS. That is, the T_proc is determined as a fixed value by the processor performance of an ANTS. Accordingly, in order to minimize the delay of a broadcasting service and support a soft combining for all ANTSs, the T_first is determined so that the T_wait is minimized. Herein, the T_first is calculated by means of the following equation 6:
T_first (n)=T_first (n−1)+T_{—}ecb−T_wait (n=2, 3, 4, . . . ) (6)

The T_wait becomes a negative number when the last data packet has arrived later than the time by which the first data packet must be transmitted wirelessly or when the last data packet has arrived without giving time for the allowance of the T_proc. Therefore, the next T_first may be delayed. An ANTS obtains the T_wait by the error control block and reports the obtained T_wait to an ANC.

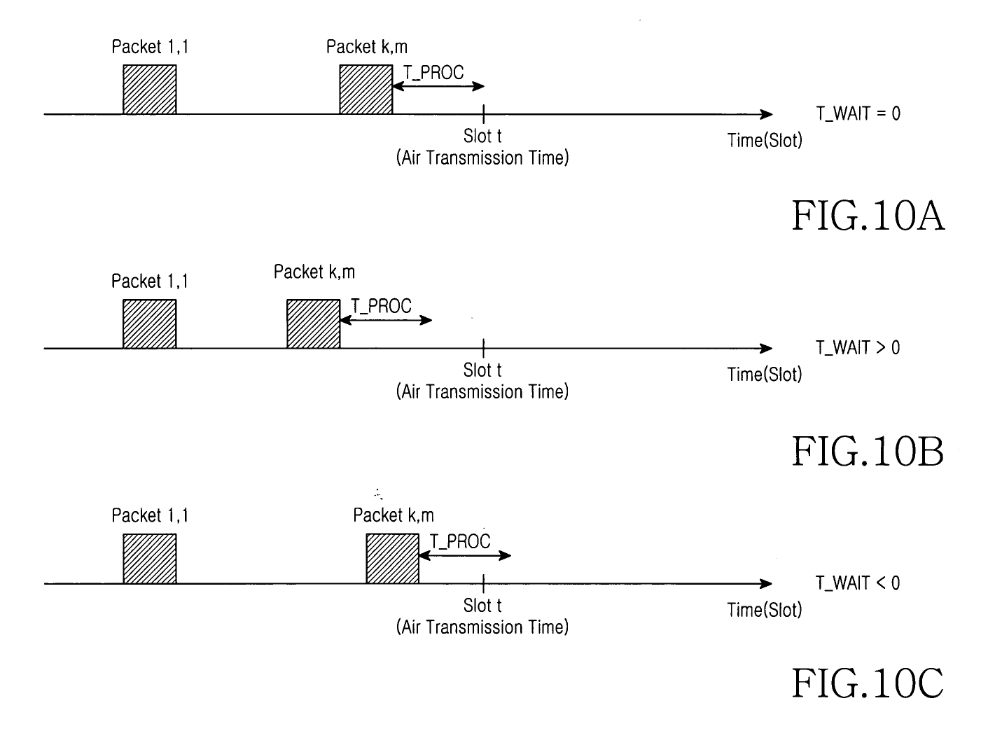

Hereinafter, a method for determining the T_wait will be described with reference to FIGS. 10a to 10c.

FIG. 10a is a diagram illustrating an example for obtaining time, which is T_PROC by subtracting the reception time of the last data packet (packet k, m) from time “slot t” at which an ANTS must transmit a first data packet wirelessly. Herein, the T_wait has a value of 0.

FIG. 10b is a diagram illustrating an example for obtaining time, which is larger than T_PROC by subtracting reception time of the last data packet (packet k, m) from time “slot t” at which an ANTS must transmit a first data packet wirelessly. Herein, the T_wait has a value larger than 0.

FIG. 10c is a diagram illustrating an example for obtaining time, which is less than T_PROC by subtracting reception time of the last data packet (packet k, m) from time “slot t” at which an ANTS must transmit a first data packet wirelessly. Herein, the T_wait has a value smaller than 0.

When receiving the T_wait from each ANTS, an ANC determines a minimum value of the T_wait and reports the minimum value to a PCF. That is, the ANC reports a T_wait of an ANTS, which has the most delayed wireless transmission time by the T_wait, to a PCF.

When receiving the minimum values of the T_wait of an ANTS, which is connected to a corresponding ANC, from each ANC, the PCF determines a minimum value of the received values again and updates a T_wait of an equation used for calculating the T_first (n) (n=2, 3, 4, . . . ). Herein, the initial value of the T_wait may become a 0 slot. However, it is preferred to allow the initial value to have a value larger than 1 slot in order to prevent the occurrence packets being prevented from being transmitted.

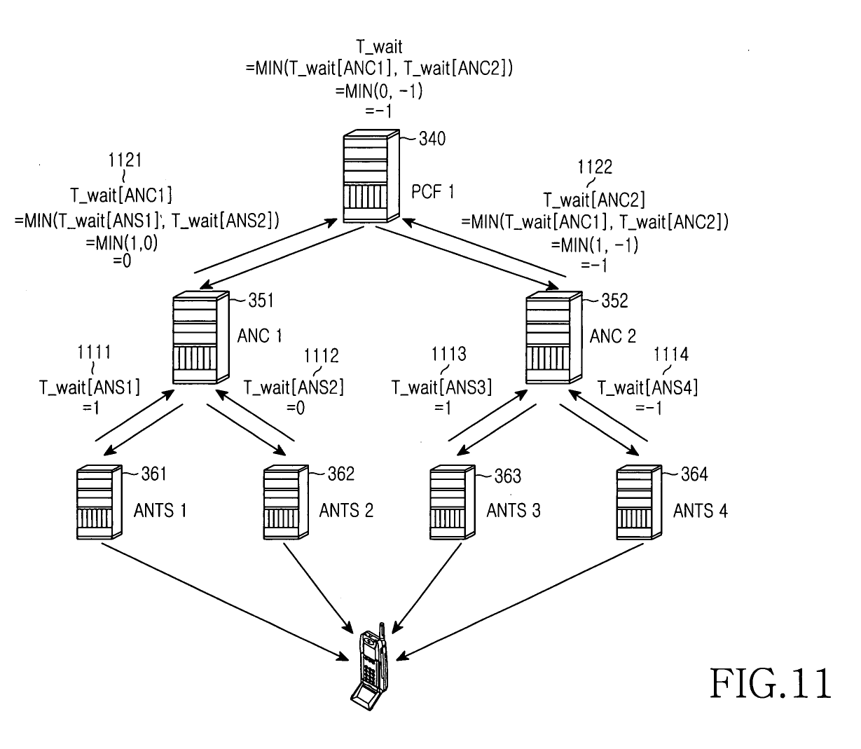

The updating procedure of the T_wait is shown in FIG. 11. Herein, the T_wait of each of the ANTSs 361 to 364 are 1, 0, 1, −1 slots for a specific error control block. That is, a transmission delay for the ANTS 364 is largest. In other words, the next T_first must be delayed by 1 slot in order to allow the T_wait not to have a value of −1. Accordingly, all ANTSs can transmit all packets to an AT wirelessly at a scheduled time.

First, in steps 1111 to 1114, each of the ANTSs 361 and 362 reports their T_wait values to the ANC 351. Further, each of the ANTSs 363 and 364 reports their T_wait values to the ANC 352. Then, each of the ANCs 351 and 352 determines a minimum value of the T_wait received from each of THE ANTSs 361 to 364 and transmits the minimum value to the PCF 340 in steps 1121 and 1122. Between the T_wait value 1 received from the ANTS 361 and the T_wait value 0 received from the ANTS 362, the ANC 351 selects the T_wait value 0 as a minimum value and transmits the selected value to the PCF 340. Similarly, between the T_wait value 1 received from the ANTS 363 and the T_wait value −1 received from the ANTS 364, the ANC 352 selects the T_wait value −1 as a minimum value and transmits the selected value to the PCF 340. Then, between the T_wait value 0 received from the ANC 351 and the T_wait value −1 received from the ANC 352, the PCF 340 selects the T_wait value −1 as a minimum value and reflects the selected value in an equation used for calculating the next T_first.

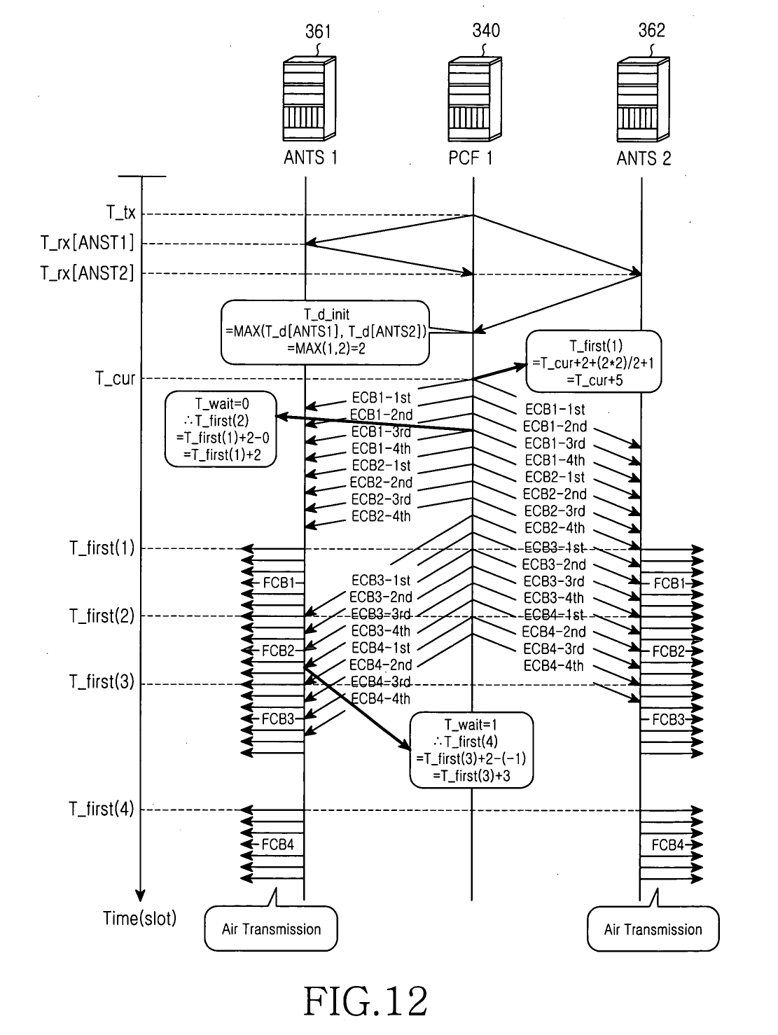

Hereinafter, an example for transmitting four error control blocks wirelessly will be described with reference to FIG. 12. In FIG. 12, it is assumed that the T_cur is 1, the T_d_init is 2, the K is 2, the R is 1, the M is 2, the T_proc is 1 and the initial value of a T_wait is 0.

In FIG. 12, an ANC is omitted. After four data packets are transmitted from a PCF to an ANTS, the ANTS adds two parity packets to the data packets and completes an error control block. Then, the ANTS transmits these six packets to an AT wirelessly at a scheduled time. Herein, in a case of transmitting the third data packet of the error control block, when the transmission delay time to the ANTS 361 has increased from 1 slot to 3 slots, the ANTS 361 does not transmit three data packets of a front portion of the corresponding error control block. Therefore, a change occurs in an equation used for calculating the wireless transmission time of the first data packet of the next error control block.

In the meantime, when the last data packet of the error control block has not arrived even though the time required for transmitting the first data packet of the error control block has elapsed, a T_wait may be updated after waiting for the arrival of the last data packet. However, this causes a delay in reflection of the transmission delay. Accordingly, in such a case, it is possible to use a method of estimating the arrival time of the last data packet and updating the T_wait. This method may also be applied to a case where the last data packet has been lost between a PCF and an ANTS. That is, when the latest received data packet is an i^{th} (i=1,2, . . . ,K*M−1) data packet and the reception time of the data packet is T_rx on the basis of time from the scheduled transmission time of the first data packet of the error control block to the T_proc, the arrival time T_rx_last of the last data packet may be calculated by means of the following equation 7:
T_{—}rx_last=T_{—}rx_{—}i+T_rest, i=1,2,3 . . . ,K*M−1 (7)

In equation 7, the T_rest, that is, time required for transmitting from an (i+1)^{th} data packet to the last data packet to the ANTS may be calculated by means of the following equation 8:
T_rest=(K*M−1)/R_{—}pkt (8)

The above description relates to a method for determining the transmission time of a packet by the PCF. In contrast, when an ANC plays a role in determining the transmission time of the packet, there exists a sole difference in that a soft combining coverage is reduced to all sectors of all ANTSs connected to the ANC, and the ANC collects transmission delay information from the ANTSs and uses the collected information in determining the transmission time of the data packet of the next error control block. Further, the basic principle is the same as that of the aforementioned description. Accordingly, a detailed description will be omitted.

In the meantime, in an embodiment of the present invention, a 1× EV-DO system has been described as an example. However, it should be apparent that the present invention can be applied to a 1× EV-DV system and other similar systems providing broadcasting services.

As described above, in an embodiment of the present invention, when a CDMA system provides a broadcasting service, the delay in broadcasting content is reduced, so that realtime characteristics of the broadcasting service can be optimally realized. Further, each ANTS transmits the same content to an AT in the same time point, so that the AT can perform a soft-combining. Therefore, it is possible to obtain packets of high quality.

Although certain embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

1. A method comprising the steps of:
receiving a measured transmission delay time from each of a plurality of access network transceiver subsystems (ANTSs);
determining a wireless transmission time of each of the plurality of ANTSs based on the largest transmission delay time of the measured transmission delay times; and
transmitting the determined wireless transmission time to the plurality of ANTSs.

2. The method in claim 1, wherein a step of receiving the measured transmission delay time comprises the steps of:
transmitting a packet, which requests a transmission delay measurement and includes the transmission time, for each of the plurality of ANTSs; and
receiving a response to a transmission delay measurement request including a reception time of the packet.

3. The method in claim 1, further comprising the steps of:
receiving a delay feedback result which is a difference between the time at which a packet has arrived at one of the plurality of ANTSs and the time at which the packet has been transmitted wirelessly; and
determining a wireless transmission time by means of the delay feedback result.

4. The method in claim 1, further comprising a step of selecting the largest transmission delay time of the measured transmission delay time as an initial value of the transmission delay time.

5. The method in claim 4, further comprising a step of transmitting the transmission delay time determined by an access network controller (ANC) to a packet control function unit (PCF).

6. The method in claim 1, wherein the ANC receives the measured transmission delay time from each of the plurality of ANTSs, selects the transmission delay time of one of the plurality of ANTSs having the largest transmission delay time of the received measured transmission delay time, and transmits the selected transmission delay time of the plurality of ANTSs to a packet control function unit (PCF).

7. A method comprising the steps of:
receiving the broadcast data packet transmitted from a packet control function unit (PCF) during a packet transmission time;
generating a parity packet during a processing time based on a Reed-Solomon code, wherein the parity packet is combined with the broadcast data packet; and
determining a transmission time of a data packet including the broadcast data and the parity packet from an access network transceiver subsystem (ANTS) based on the packet transmission time and the processing time.

8. The method in claim 7, wherein a transmission time of a data packet is determined based on the packet transmission time, the processing time and a waiting time.

9. The method in claim 8, wherein the waiting time is a negative number when a last data packet has arrived later than the time by which a first data packet must be transmitted wirelessly or when the last data packet has arrived without allowance for the processing time.

10. An apparatus for transmitting broadcast data in a mobile communication system to an Access Terminal (AT) through a plurality of access network transceiver subsystems (ANTSs), the apparatus comprising:
a packet control function (PCF) for receiving a measured transmission delay time from an access network controller (ANC), determining a wireless transmission time on the basis of the largest transmission delay time of the received measured transmission delay time; and
an ANTS for measuring the transmission delay time according to the transmission delay time measurement request of the PCF, transmitting the measured transmission delay time to the ANC, and transmitting the broadcast data to the AT by means of the wireless transmission time received through the ANC,
wherein the ANC is operable to receive the measured transmission delay time from the ANTS, select the largest transmission delay time of the measured transmission delay time, transmit the selected transmission delay time to the PCF, and transmit the wireless transmission time received from the PCF and broadcasting data to the ANTS.

11. The apparatus of claim 10, wherein the ANTS receives a packet requesting a transmission delay measurement and including the transmission time, and receives a response to the transmission delay measurement request including a reception time of the packet.

12. The apparatus of claim 10, wherein the ANTS receives a delay feedback result which is a difference between the time at which a packet has arrived at the ANTS and the time at which the packet has been transmitted wirelessly, and determines a wireless transmission time by means of the delay feedback result.

13. The apparatus of claim 10, wherein the ANTS selects the largest transmission delay time of the measured transmission delay time as an initial value of the transmission delay time.

14. The apparatus of claim 10, wherein the ANT communicates with the AT at a scheduled time.

15. The apparatus of claim 10, wherein the ANC receives the measured transmission delay time from each ANTS, selects the transmission delay time of the ANTS having the largest transmission delay time of the received measured transmission delay time, and transmits the selected transmission delay time of the ANTS to the PCF.
